(19) United States
(12) Patent Application Publication
(10) Pub. No.: US 2017/0353060 A1
(43) Pub. Date: Dec. 7, 2017

(54) OVER THE AIR CHARGING SHIELD

(71) Applicant: ESMART TECH, INC., San Diego, CA (US)

(72) Inventors: Ying Xiong, San Diego, CA (US); Kenny Fok, San Diego, CA (US); David Diplock, Alpine, CA (US); Niral Bhalodia, San Diego, CA (US)

(21) Appl. No.: 15/600,658

(22) Filed: May 19, 2017

Related U.S. Application Data
(60) Provisional application No. 62/345,742, filed on Jun. 3, 2016.

(51) Int. Cl. H02J 50/70; H02J 50/80; H02J 50/40; H02J 7/02

(52) U.S. Cl. CPC H02J 50/70; H02J 7/025; H02J 50/80; H02J 50/40

(57) ABSTRACT

A safety shield for over the air (OTA) charging includes: a structural element having: a first surface that reflects and refracts OTA charging transmissions; and a second surface that obstructs and absorbs OTA charging transmissions. An OTA charging system includes: an OTA charging station; and a safety shield movably coupled to the OTA charging station. An OTA charging device includes: a housing; at least one OTA transmitter positioned inside the housing; and a safety shield coupled to the housing.

### CROSS-REFERENCE TO RELATED APPLICATIONS

This application claims priority to U.S. Provisional Patent Application Ser. No. 62/345,742, filed on Jun. 3, 2016.

### BACKGROUND

Many user devices such as smartphones, tablets, wearable devices, etc. may utilize over-the-air (OTA) charging. OTA charging may generate electromagnetic interference, radio frequency interference, and/or other interference associated with transmitted power.

Such interference raises various safety concerns. Many users may want to conveniently charge devices using OTA charging but may want some protection from radiation or interference associated with such charging.

Therefore there exists a need for a shield that is able to allow OTA charging while protecting people, pets, and/or objects.

### SUMMARY

Some embodiments provide a physical shield for use with OTA charging. The shield may include a planar element that forms a conical or umbrella shape. One surface of the shield (e.g., the interior surface of the umbrella) may be reflective and/or refractive. Such qualities may be provided by various appropriate materials adhered to, embedded with, and/or otherwise included with at least of portion of the surface. Another surface of the shield (e.g., the exterior surface of the umbrella) may be obstructive and/or absorptive.

During use, the shield may be coupled to and/or placed over one or more OTA transmitters (and/or otherwise be positioned to at least partly block signals transmitted from the OTA transmitter(s)). The transmitter(s) and shield may provide an adjustable coverage area. The adjustable coverage area may be configured by adjusting the power of the OTA transmitter(s) and/or adjusting the position of the shield (e.g., raising or lowering the shield, modifying the radius of the cone, changing the shape of the shield, etc.). In some embodiments, multiple shields may be used to provide an irregularly shaped coverage area, and/or to otherwise define the coverage area.

Some embodiments may include a set of light emitting diodes (LEDs) and/or other appropriate visual indicators that may provide a visual indication of the coverage area (i.e., the area where OTA charging is permitted by the shield).

Different embodiments may be shaped in various different ways, as appropriate (e.g., rectangular shapes may correspond to rectangular tables or desks, round shapes may correspond to round tables, etc.). In addition, different embodiments may be sized differently, depending on various relevant factors (e.g., the number of devices the OTA transmitter(s) are capable of charging, the size of the surface used to support devices being charged, etc.).

In some embodiments, the shield may be coupled to the OTA charger or transmitter(s) and/or otherwise associated with the transmitter(s).

Some embodiments may include wireless communication capabilities and/or other features that allow the shield to interact with the charger, devices being charged, and/or other appropriate devices. For instance, some embodiments may be able to be at least partly controlled using an app that runs on a mobile device.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of an over the air (OTA) charging system according to an exemplary embodiment;

FIG. 2 illustrates a front elevation view of the OTA charging system of FIG. 1;

FIG. 3 illustrates a top view of the OTA charging system of FIG. 1;

FIG. 4 illustrates a front elevation view of the OTA charging system of FIG. 1, showing a charging range at a first height and a first power level;

FIG. 5 illustrates a front elevation view of the OTA charging system of FIG. 1, showing a charging range at a second power level;

FIG. 6 illustrates a front elevation view of the OTA charging system of FIG. 1, showing a charging range at a second height;

FIG. 7 illustrates a top view of the OTA charging system of FIG. 1, showing a charging range for a first example configuration;

FIG. 8 illustrates a top view of the OTA charging system of FIG. 1, showing a charging range for a second example configuration;

FIG. 9 illustrates a top view of the OTA charging system of FIG. 1, showing a charging range for a third example configuration;

FIG. 10 illustrates a top view of the OTA charging system of FIG. 1, showing a charging range for a fourth example configuration;

FIG. 11 illustrates a flow chart of an exemplary process that controls the OTA charging system of FIG. 1;

FIG. 12 illustrates a flow chart of an exemplary process that provides a visual indication of charging range for the OTA charging system of FIG. 1;

FIG. 13 illustrates a flow chart of an exemplary process that adjusts the OTA charging system of FIG. 1 based on a visual indication of charging range; and

FIG. 14 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide an over the air (OTA) charging system and safety shield.

Throughout the specification and appendix, terms such as “radio frequency” or “RF” may be used to refer to any wireless signal without limitation to a particular frequency spectrum.

A first exemplary embodiment provides a safety shield for over the air (OTA) charging, the safety shield comprising: a structural element having: a first surface that reflects and refracts OTA charging transmissions; and a second surface that obstructs and absorbs OTA charging transmissions.

A second exemplary embodiment provides an over the air (OTA) charging system comprising: an OTA charging station; and a safety shield movably coupled to the OTA charging station.

A third exemplary embodiment provides an over the air (OTA) charging device comprising: a housing; at least one OTA transmitter positioned inside the housing; and a safety shield coupled to the housing.

Several more detailed embodiments are described in the sections below. Section I provides a description of a hardware architecture of some embodiments. Section II then describes a charging shield of some embodiments. Next, Section III describes various exemplary configurations used by some embodiments. Section IV then describes various methods of operation used by some embodiments. Lastly, Section V describes a computer system which implements some of the embodiments.

### I. Hardware Architecture

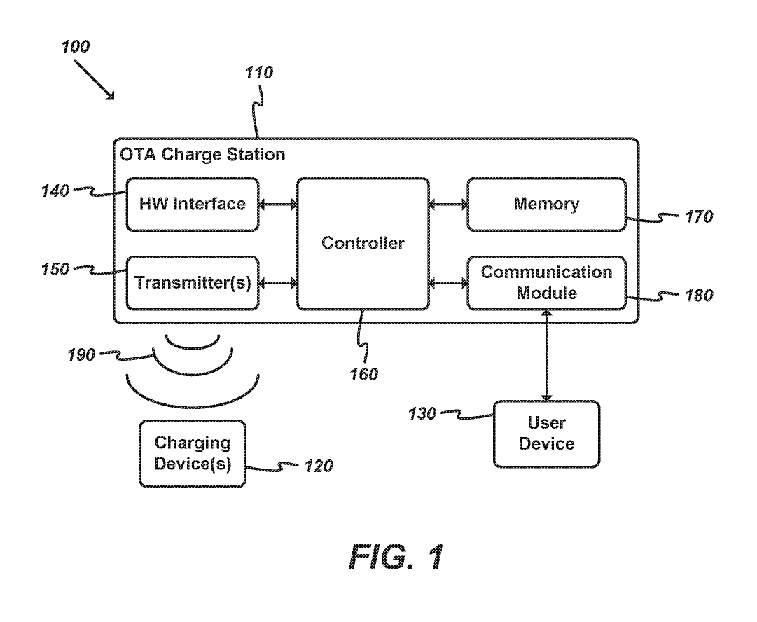

FIG. 1 illustrates a schematic block diagram of an OTA charging system 100 according to an exemplary embodiment. As shown, the system may include an OTA charging station 110, a number of charging devices 120, and a controller device 130. The charging station may include a hardware interface 140, set of transmitters 150, a controller 160, memory 170, and a communication module 180. The safety shield of some embodiments is omitted for clarity in this view.

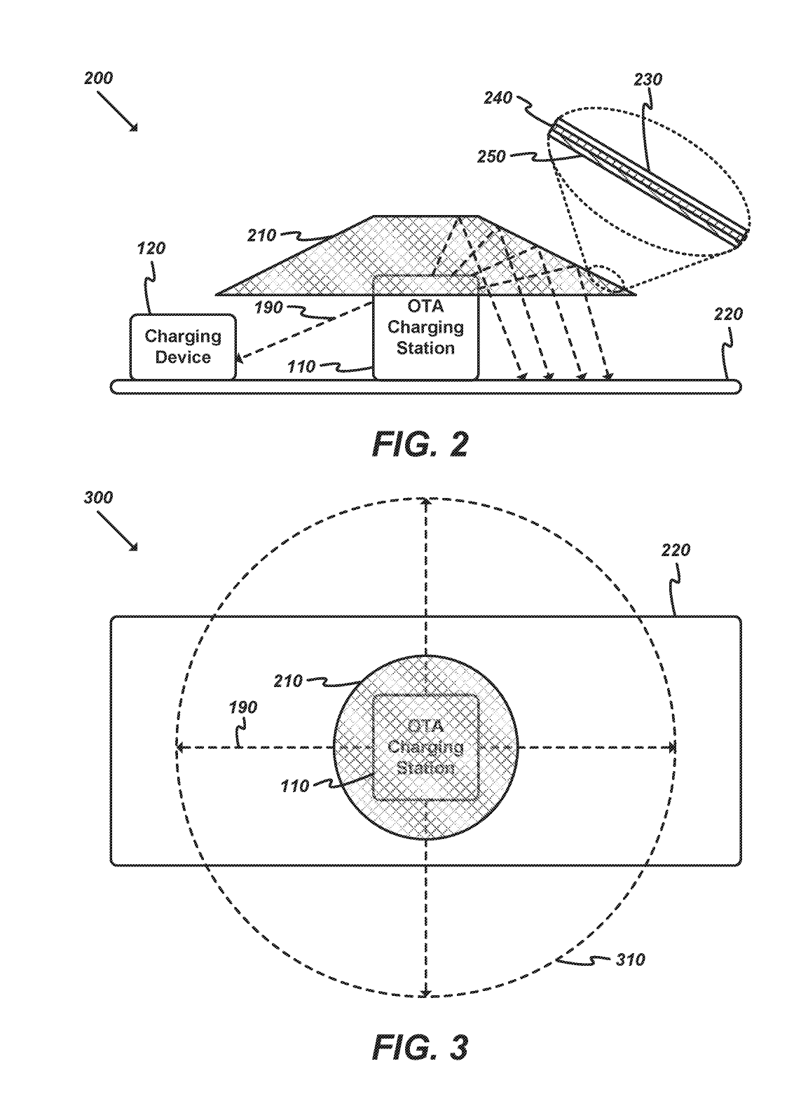

The OTA charging station 110 may be an electronic device having a housing or enclosure and attached safety shield. One exemplary device will be described in more detail in reference to FIG. 2.

The charging devices 120 may be electronic devices having rechargeable batteries that are able to use wireless charging. Such devices may include, for instance, smartphones, tablets, wearable devices, etc.

The user device 130 may be an electronic device such as a smartphone, tablet, personal computer, etc. that is able to communicate with the OTA station 110 over one or more wired or wireless connections. In addition, the user device 130 may include various user interface (UI) features such as buttons, keypads, displays, touchscreens, microphones, speakers, etc. Of course, user device 130 may also be a charging device 120 (i.e., the user device 130 may communicate with the OTA station 110 while also receiving charging power from the transmitter(s) 150).

The OTA charging station 110 may include such UI features in some embodiments. The UI features may allow a user to position or manipulate the safety shield and/or otherwise control various aspects of the charging station operation (e.g., setting charging power level, range, enabling visual indicators, etc.) and/or provide feedback to users regarding status or other appropriate information.

The hardware interface 140 may be able to interact with various motors, actuators, etc. such that the shield is able to be automatically adjusted (e.g., by activating a motor attached to a linear gear to raise or lower the shield, by controlling an actuator or other physical device capable of changing the shape or dimensions of the safety shield, etc.).

In addition, the hardware interface may be able to at least partly control the output of any visual indicators (e.g., LEDs). The visual indicators may be activated, deactivated, intensity adjusted, and/or otherwise be controlled by a user.

The hardware interface may also be able to interact with various UI features in order to receive user inputs and provide information to users.

The transmitter(s) 150 may be able to generate an OTA signal 190 that is able to charge one or more charging devices. Some embodiments may include multiple transmitters (and/or multiple antennae) in various arrangements. For instance, some embodiments may provide a three hundred sixty degree coverage area using an array of transmitters and/or antennae.

The controller 160 may be able to interact with and/or direct the operations of the various other system elements. For instance, the controller may define various transmission parameters (e.g., power) and/or generate commands that are used to control the transmitters 150. As another example, the controller 160 may define parameters and/or generate commands used to control the hardware interface 140 (and thus the associated hardware components such as motors or actuators, UI features, etc.).

The memory 170 may be able to store data and/or instructions for use by the components of system 100.

The communication module 180 may be able to interact with various external devices (such as a smartphone or other user device 130) via a wired or wireless connection (e.g., Bluetooth, Wi-Fi, universal serial bus (USB), etc.) such that the external user device 130 may be able to at least partly control the operations of the charging station (e.g., power level, shield position, etc.).

One of ordinary skill in the art will recognize that the charging system 100 may be implemented in various different ways without departing from the scope of the disclosure. For instance, some embodiments may provide a stand-alone shield without any other associated hardware. As another example, some embodiments may provide wired charging ports (e.g., a USB charging port).

### II. Charging Shield

FIG. 2 illustrates a front elevation view of the OTA charging system 100. In this view, the charging station 110 includes shield 210 and the charging station 110 and device being charged 120 both rest on a flat surface 220 such as a table.

In this example, the OTA signal 190 is represented as a number of dashed lines. As shown, the OTA signals may be reflected and absorbed by the shield 210, while the signals 190 may be able to pass under the shield 210 to reach the charging device 120.

The shield 210 may be attached to the charging station 110 using various moveable supports, frames, etc. Such attachment elements are omitted for clarity. The attachment elements may be able to automatically move the shield 210 up or down and/or modify the shape of the shield.

The shield may include an outer layer 230, a structural layer 240, and an inner layer 250. The structural layer 240 may include various support elements (e.g., a metal frame) and/or be made from flexible material able to hold a particular shape (e.g., plastic, metal, composites, etc.).

The outer layer 230 may include material for blocking and absorbing radio and electromagnetic waves. Such material may include, for instance, copper, cloth painted with RF shielding paint, etc.

The inner layer 250 may include material for reflecting and refracting radio and electromagnetic waves. Such material may include, for instance, glass, plastic, etc.

In some embodiments, the layers may be combined into a single element. For instance, a plastic structural layer may be coated on one surface with RF shielding paint while the other surface may have reflective and refractive properties. Some embodiments may include additional layers or elements. For instance, some embodiments may include a support frame or skeleton that may be attached to or embedded into another structural component.

FIG. 3 illustrates a top view of the OTA charging system 100. This view shows a charging range 310 of the device. In this example, the shield 210 has a round shape and the range 310 is also round.

### III. Exemplary Configurations

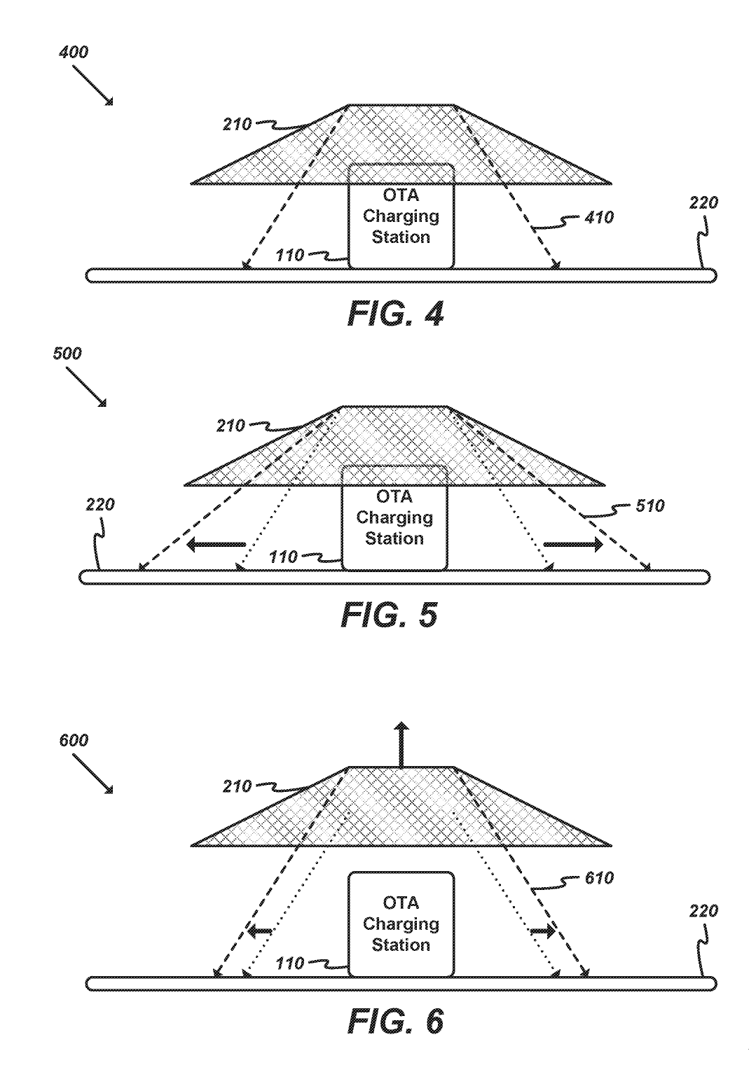

FIG. 4 illustrates a front elevation view of the OTA charging system 100, showing a charging range at a first height and a first power level. In this example, the OTA charging signal range 410 may be indicated by LEDs or other light sources arranged around the interior rim of the shield 210 (light source omitted for clarity).

FIG. 5 illustrates a front elevation view of the OTA charging system 100, showing a charging range at a second power level. In this example, the charging range 510 is expanded as shown due to the second power level being greater than the first power level.

FIG. 6 illustrates a front elevation view of the OTA charging system 100, showing a charging range at a second height. In this example, the charging range 610 is increased as shown due to the second height being greater than the first height.

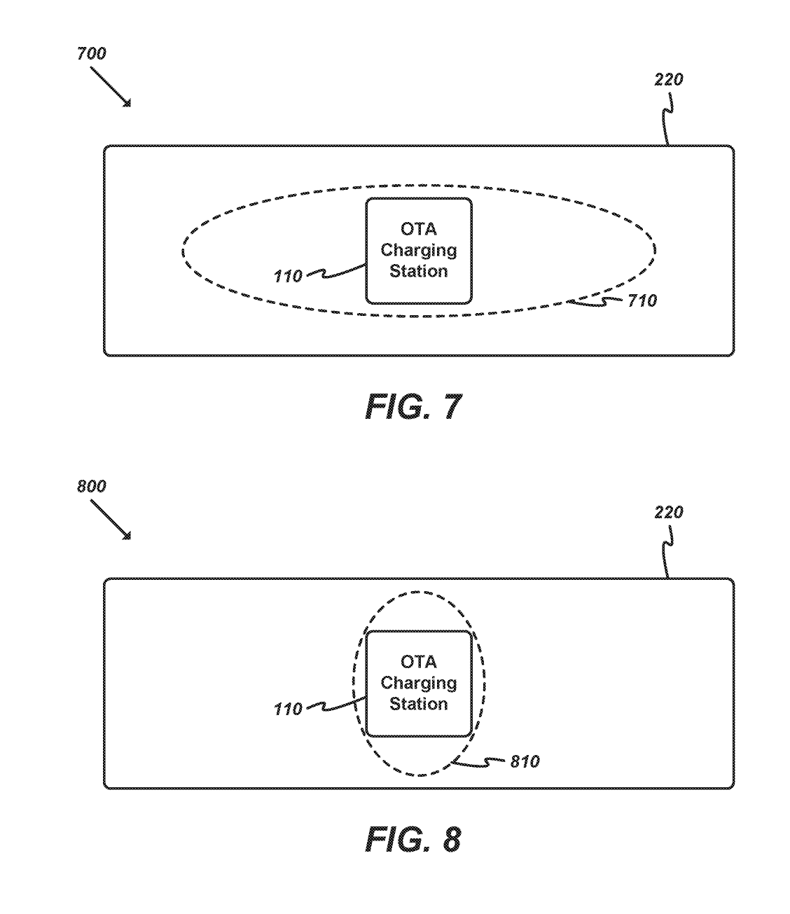

FIG. 7 illustrates a top view of the OTA charging system 100, showing a charging range for a first example configuration. In this example, the shape of the shield 210 and/or the directional power levels may be adjusted such that the charging range 710 has an oval shape that does not extend to the edges of the table 220.

FIG. 8 illustrates a top view of the OTA charging system 100, showing a charging range for a second example configuration. In this example, the shape of the shield 210 and/or the directional power levels may be adjusted such that the charging range 810 has an oval shape that reaches only a small portion of the table 220.

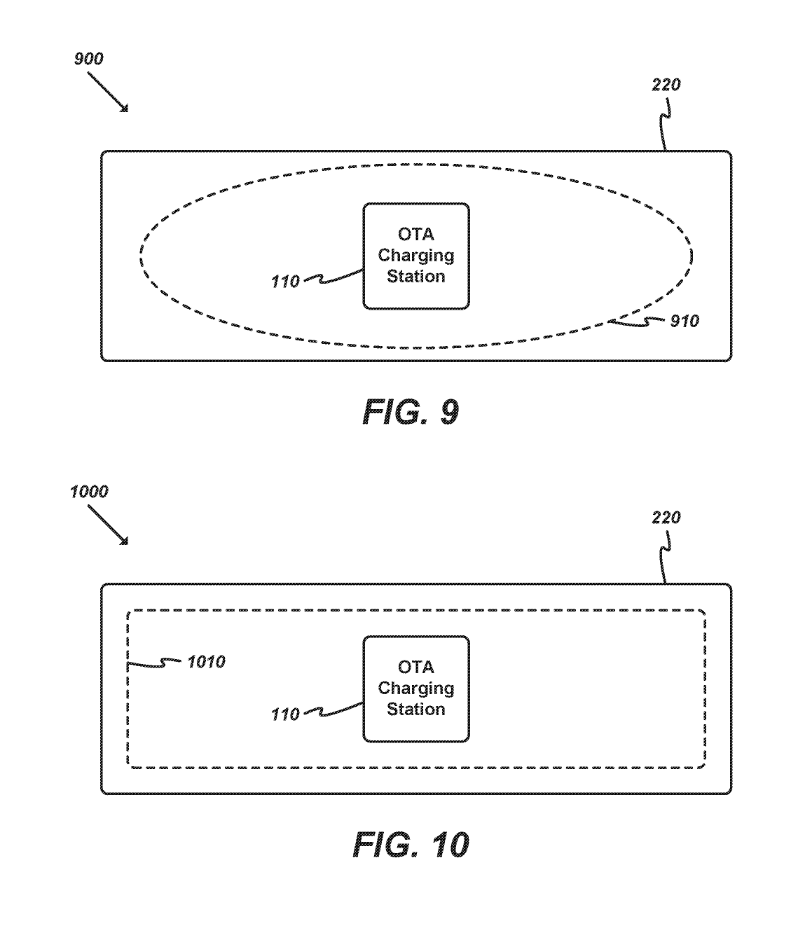

FIG. 9 illustrates a top view of the OTA charging system 100, showing a charging range for a third example configuration. In this example, the shape of the shield 210 and/or the directional power levels may be adjusted such that the charging range 710 has an oval shape that extends nearly to the edges of the table 220.

FIG. 10 illustrates a top view of the OTA charging system 100, showing a charging range for a fourth example configuration. In this example, the shape of the shield 210 and/or the directional power levels may be adjusted such that the charging range 1010 has a rectangular shape that better matches the shape and size of the table 220 and extends nearly to the edges of the table.

One of ordinary skill in the art will recognize that the embodiments of FIG. 4-FIG. 10 are provided for example purposes and that other embodiments may have differently sized or shaped charging ranges.

### IV. Methods of Operation

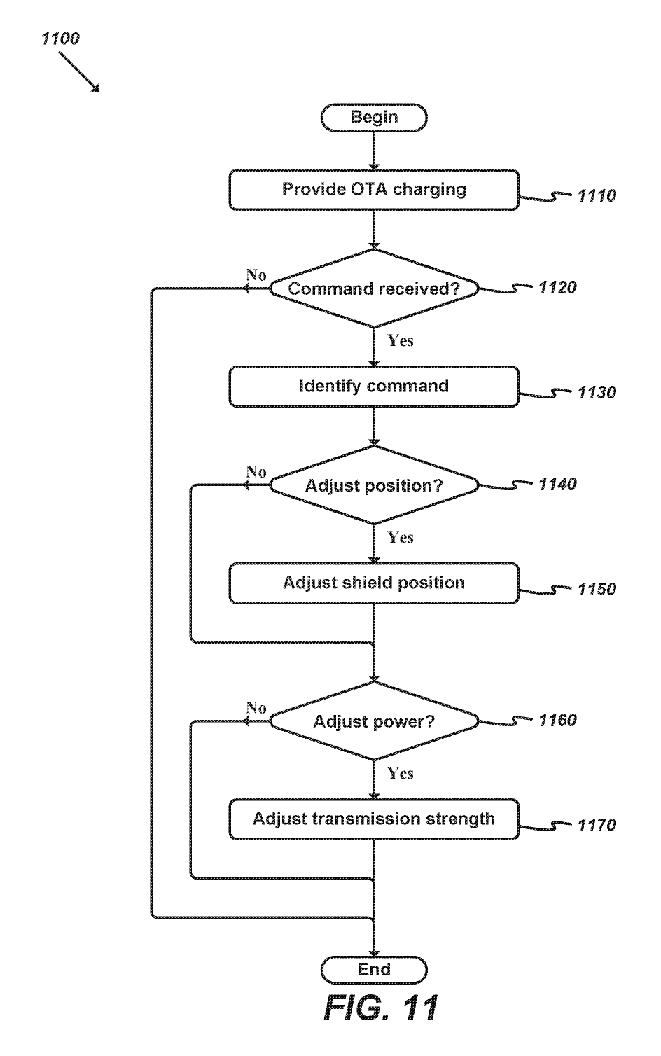

FIG. 11 illustrates a flow chart of an exemplary process 1100 that controls the OTA charging system 100. Such a process may begin, for instance, when the OTA charging station of some embodiments is powered on.

As shown, the process may provide (at 1110) OTA charging. Such charging may be based on default operating parameters, parameters associated with most recent usage, and/or other appropriate parameters (e.g., user defined preferences). In some embodiments, charging may not begin until various parameters are selected and/or set (e.g., transmission power).

Next, the process may determine (at 1120) whether a command has been received. Such a command may be received from an external device, such as a smartphone using a wired or wireless communication link. Alternatively and/or conjunctively, a command may be received from a user interface element provided by the OTA charging station (e.g., a button, knob, etc.).

If the process determines that no command has been received, the process may end. If the process determines that a command has been received, the process may then identify (at 1130) the command and/or any associated parameters.

Next, the process may determine (at 1140) whether the position of the shield should be adjusted based on the identified command. If the process determines that the position needs to be adjusted, the process may adjust (at 1150) the shield position and/or shape. Such adjustment may include sending commands via an element such as the hardware interface of some embodiments in order to manipulate various motors, actuators, etc. that are able to at least partly control the position and/or shape of the shield.

After adjusting the position or determining that no adjustment is needed, the process may determine (at 1160) whether the transmission power should be adjusted based on the received command. If the process determines that the power should be adjusted, the process may then adjust (at 1170) the transmission strength. Such an adjustment may be made by a component such as the controller in conjunction with one or more transmitters.

After adjusting the transmission strength or after determining that no adjustment should be made, the process may end.

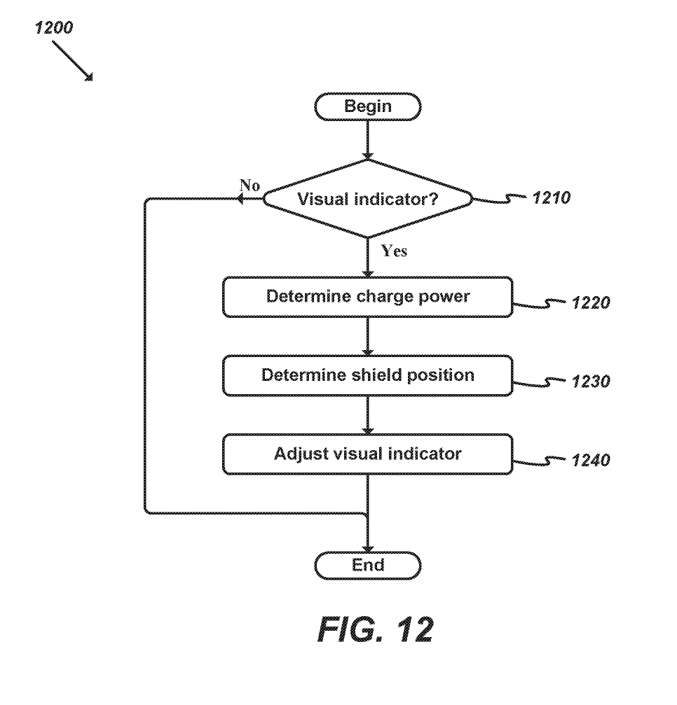

FIG. 12 illustrates a flow chart of an exemplary process 1200 that provides a visual indication of charging range for the OTA charging system 100. Such a process may begin, for instance, when the OTA charging station of some embodiments is powered on.

As shown, the process may determine (at 1210) whether a visual indicator is available and/or active. Such a determination may be made based on various relevant factors (e.g., capabilities of the charging station or shield, user selection, etc.

If the process determines (at 1210) that the visual indicator is not available or active, the process may end. If the process determines that a visual indicator is available or active, the process may determine (at 1220) the charging power. Such a determination may be made by retrieving a power level from the charging station, where the power level may be based on default settings, user-defined settings, and/or other appropriate factors.

Next, the process may determine (at 1230) the shield position and/or shape. Such a determination may be made in various appropriate ways. For instance, some embodiments may include motors, actuators, and the like that may be able to supply position information upon request (and/or such data may be stored by a resource such as the charging station of some embodiments). As another example, some embodiments may include various sensors that may be able to determine a position and/or shape of the shield.

The process may then adjust (at 1240) the visual indicators, if needed, and then may end. Such adjustment may include, for instance, modifying voltage or current supplied to the visual indicators, changing the position or orientation of the visual indicators, activating and/or deactivating various indicators, etc. In some embodiments, the visual indicators may be used statically, such that the visual indication tracks the physical position or shape of the shield and no further adjustment is needed.

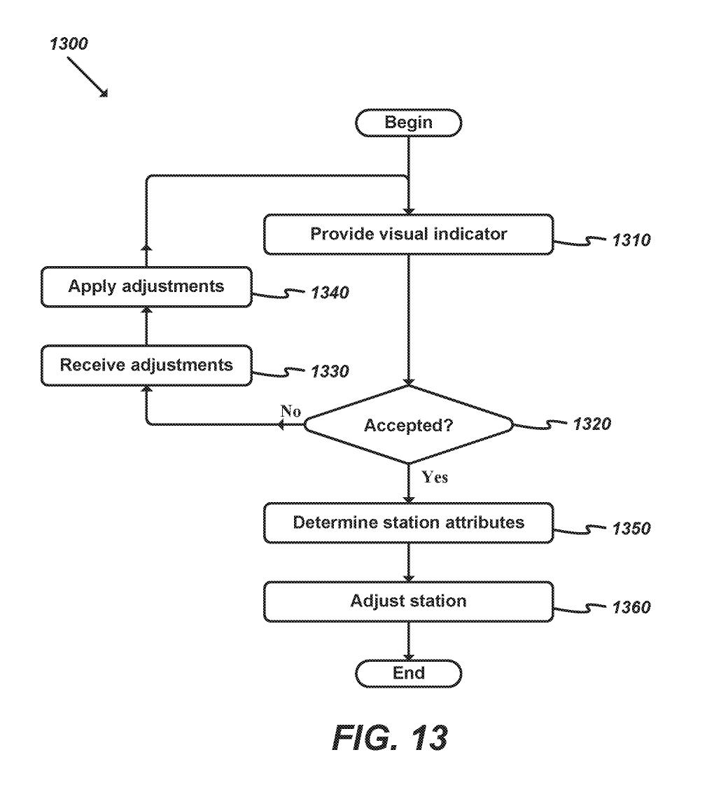

FIG. 13 illustrates a flow chart of an exemplary process 1300 that adjusts the OTA charging system 100 based on a visual indication of charging range. Such a process may begin, for instance, when the OTA charging station of some embodiments is powered on.

As shown, the process may provide (at 1310) a visual indicator of the charging range. As described above, such an indicator may be provided by a set of LEDs or other appropriate elements that are able to generate a visual indication of the range. Next, the process may determine (at 1320) whether the indicated range is accepted by a user. Such a determination may be made based on various relevant factors (e.g., explicit command or input received from a user, time elapsed since last received command, etc.).

If the process determines (at 1320) that the currently indicated range is not accepted, the process may receive (at 1330) adjustments to the range, apply (at 1340) the received adjustments, and provide (at 1310) a visual indicator of the updated range. Such adjustments may involve changes to the orientation, power, etc. of the LEDs or other visual generators.

The adjustments may be made using an app of some embodiments. For instance, a user may be able to select from among a set of defined shapes or from a set of available ranges (e.g., one foot, five feet, ten feet, etc.). As another example, a user may be able to enter a radius or distance for the range. Some embodiments may include UI elements such as buttons, joysticks, keypads, etc. that may allow a user to adjust the range (in terms of shape and/or distance) on the OTA station 100 itself.

If the process determines (at 1320) that the currently indicated range is accepted, the process may determine (at 1350) the charging station attributes associated with the indicated range. Such attributes may include, for instance, shield attributes (e.g., height, shape, etc.) and/or station attributes (e.g., transmission power, transmitter selection, etc.). The attributes may be received from a database or lookup table associated with current visual indicator settings. Alternatively or conjunctively, some embodiments may calculate attributes based on the indicated range (e.g., transmission power may be calculated based on a distance of the visual indicator).

Next, the process may adjust (at 1360) the station based on the determined attributes and then may end. Such adjustment may include moving the shield (e.g., adjusting the height), changing the shape of the shield, changing the transmission power of one or more transmitters, and/or other appropriate adjustments.

One of ordinary skill in the art will recognize that processes 1100, 1200, and 1300 may be implemented in various appropriate ways without departing from the scope of the disclosure. For instance, additional operations may be included or some listed operations may be omitted. As another example, various operations or sets of operations may be performed iteratively and/or based on some criteria. The operations may also be performed in different orders than shown. Furthermore, the processes may be divided into multiple sub-processes and/or combined into a larger macro process.

### V. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (D SP s), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

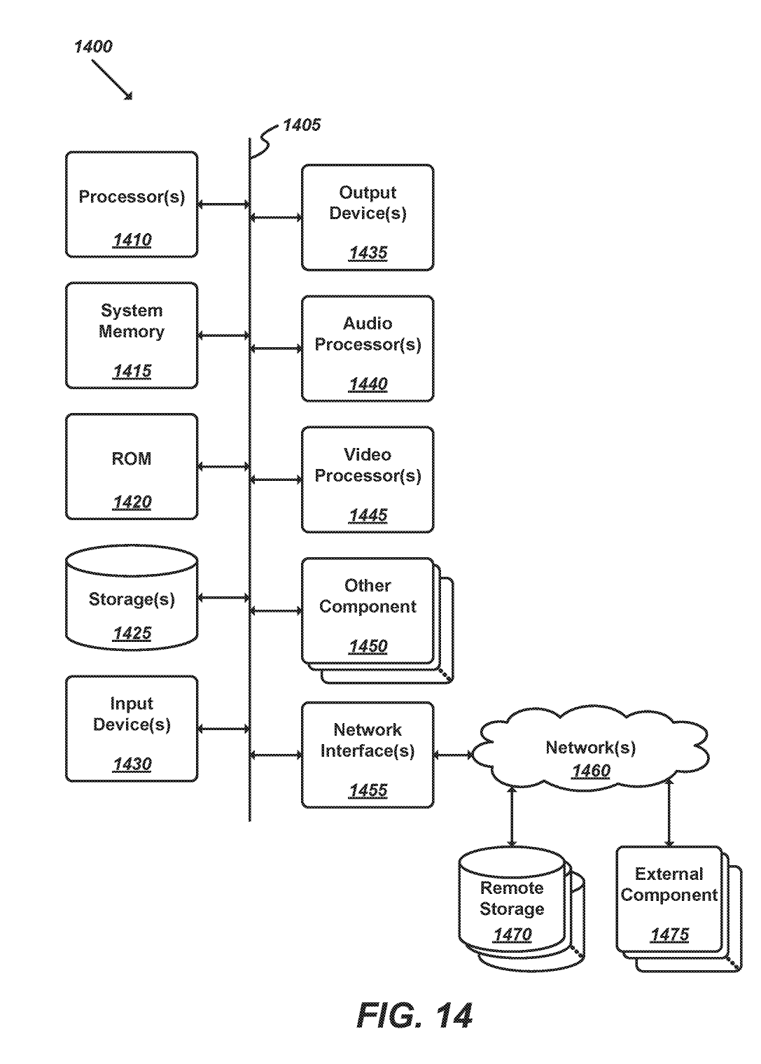

FIG. 14 illustrates a schematic block diagram of an exemplary computer system 1400 used to implement some embodiments. For example, the system described above in reference to FIG. 1-FIG. 2 may be at least partially implemented using computer system 1400. As another example, the processes described in reference to FIG. 11-FIG. 13 may be at least partially implemented using sets of instructions that are executed using computer system 1400.

Computer system 1400 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1400 may include at least one communication bus 1405, one or more processors 1410, a system memory 1415, a read-only memory (ROM) 1420, permanent storage devices 1425, input devices 1430, output devices 1435, audio processors 1440, video processors 1445, various other components 1450, and one or more network interfaces 1455.

Bus 1405 represents all communication pathways among the elements of computer system 1400. Such pathways may include wired, wireless, optical, and/or other appropriate communication pathways. For example, input devices 1430 and/or output devices 1435 may be coupled to the system 1400 using a wireless connection protocol or system.

The processor 1410 may, in order to execute the processes of some embodiments, retrieve instructions to execute and/or data to process from components such as system memory 1415, ROM 1420, and permanent storage device 1425. Such instructions and data may be passed over bus 1405.

System memory 1415 may be a volatile read-and-write memory, such as a random access memory (RAM). The system memory may store some of the instructions and data that the processor uses at runtime. The sets of instructions and/or data used to implement some embodiments may be stored in the system memory 1415, the permanent storage device 1425, and/or the read-only memory 1420. ROM 1420 may store static data and instructions that may be used by processor 1410 and/or other elements of the computer system.

Permanent storage device 1425 may be a read-and-write memory device. The permanent storage device may be a non-volatile memory unit that stores instructions and data even when computer system 1400 is off or unpowered. Computer system 1400 may use a removable storage device and/or a remote storage device as the permanent storage device.

Input devices 1430 may enable a user to communicate information to the computer system and/or manipulate various operations of the system. The input devices may include keyboards, cursor control devices, audio input devices and/or video input devices. Output devices 1435 may include printers, displays, audio devices, etc. Some or all of the input and/or output devices may be wirelessly or optically connected to the computer system 1400.

Audio processor 1440 may process and/or generate audio data and/or instructions. The audio processor may be able to receive audio data from an input device 1430 such as a microphone. The audio processor 1440 may be able to provide audio data to output devices 1440 such as a set of speakers. The audio data may include digital information and/or analog signals. The audio processor 1440 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 1445 (or graphics processing unit) may process and/or generate video data and/or instructions. The video processor may be able to receive video data from an input device 1430 such as a camera. The video processor 1445 may be able to provide video data to an output device 1440 such as a display. The video data may include digital information and/or analog signals. The video processor 1445 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 1450 may perform various other functions including providing storage, interfacing with external systems or components, etc.

Finally, as shown in FIG. 14, computer system 1400 may include one or more network interfaces 1455 that are able to connect to one or more networks 1460. For example, computer system 1400 may be coupled to a web server on the Internet such that a web browser executing on computer system 1400 may interact with the web server as a user interacts with an interface that operates in the web browser. Computer system 1400 may be able to access one or more remote storages 1470 and one or more external components 1475 through the network interface 1455 and network 1460. The network interface(s) 1455 may include one or more application programming interfaces (APIs) that may allow the computer system 1400 to access remote systems and/or storages and also may allow remote systems and/or storages to access computer system 1400 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

We claim:

1. A safety shield for over the air (OTA) charging, the safety shield comprising:
a structural element having:
a first surface that reflects and refracts OTA charging transmissions; and
a second surface that obstructs and absorbs OTA charging transmissions.

2. The safety shield of claim 1, wherein the first surface comprises at least one of glass and plastic.

3. The safety shield of claim 1, wherein the second surface comprises at least one of copper and radio frequency shielding paint.

4. The safety shield of claim 1, wherein the structural element has an umbrella shape that is round when viewed from above and trapezoidal when viewed from a side elevation.

5. The safety shield of claim 1, wherein the safety shield is coupled to an OTA charging transmitter and a height of the safety shield with respect to the OTA charging transmitter is adjustable.

6. The safety shield of claim 5 further comprising a plurality of visual indicators that provide an indication of an OTA charging range provided by the safety shield.

7. The safety shield of claim 6, wherein the indication of the OTA charging range may be adjusted and at least one of a position of the safety shield and a transmission strength of the OTA charging station is determined based on the adjusted indication of the OTA charging range.

8. An over the air (OTA) charging system comprising:
an OTA charging station; and
a safety shield movably coupled to the OTA charging station.

9. The OTA charging system of claim 8, wherein the OTA charging station comprises:
an OTA transmitter able to provide an OTA charging signal;
a communication module able to communicate with a user device; and
a hardware interface able to manipulate a position of the safety shield relative to the OTA charging station.

10. The OTA charging system of claim 9, wherein the hardware interface is further able to manipulate a shape of the safety shield.

11. The OTA charging system of claim 9, wherein the OTA transmitter has a variable power output.

12. The OTA charging system of claim 9, wherein the hardware interface is communicatively coupled to at least one linear actuator that is able to control a height of the safety shield.

13. The OTA charging system of claim 8, further comprising a set of light emitting diodes that provide a visual indication of charging range.

14. The OTA charging system of claim 8, wherein the safety shield comprises a first surface that reflects and refracts OTA charging transmissions; and a second surface that obstructs and absorbs OTA charging transmissions.

15. An over the air (OTA) charging device comprising:
a housing;
at least one OTA transmitter positioned inside the housing; and
a safety shield coupled to the housing.

16. The OTA charging device of claim 15, wherein the safety shield is coupled to the housing via a linear actuator that is able to adjust a height of the safety shield relative to the housing.

17. The OTA charging device of claim 15, wherein the safety shield has an umbrella shape.

18. The OTA charging device of claim 15, wherein the safety shield comprises a first material that reflects and refracts OTA charging transmissions; and a second material that obstructs and absorbs OTA charging transmissions.

19. The OTA charging device of claim 15 further comprising a communication module that is able to communicate with a user device.

20. The OTA charging device of claim 19, wherein a power level of the at least one OTA transmitter and a position of the safety shield is able to be updated based on communications received from the user device.
